(19) United States
(12) Patent Application Publication
(10) Pub. No.: US 2014/0081718 A1
(43) Pub. Date: Mar. 20, 2014

(54) METHOD, RADIO BEACON AND ONBOARD UNIT FOR GENERATING PARKING FEE TRANSACTIONS

(71) Applicant: Kapsch TrafficCom AG, Vienna (AT)

(72) Inventors: Alexander Leopold, Wien (AT); Robert Povolny, Wien (AT); Oliver Nagy, Wien (AT)

(73) Assignee: Kapsch TrafficCom AG, Vienna (AT)

(21) Appl. No.: 14/023,769

(22) Filed: Sep. 11, 2013

(30) Foreign Application Priority Data
Sep. 17, 2012 (EP) 12184676.0

(51) Int. Cl. G07B 15/02

(52) U.S. Cl. CPC G07B 15/02
USPC 705/13

(57) ABSTRACT

A method for generating a parking fee transaction for a vehicle that comprises an onboard unit having an identifier, and a radio beacon and an onboard unit for carrying out the method, are provided. The method includes: wirelessly polling the identifier by a roadside radio beacon as a current identifier, generating a parking fee transaction for the identifier if the current identifier is identical to a stored old identifier, storing the current identifier as the old identifier, waiting a predetermined time period, and repeating these steps.

### CROSS-REFERENCE TO RELATED APPLICATION(S)

This application claims priority to European Patent Application No. 12 184 676.0, filed on Sep. 17, 2012, the entirety of which is incorporated by reference herein.

### BACKGROUND

1. Technical Field

The present patent application relates to a method for generating a parking fee transaction for a vehicle, which comprises an onboard unit having an identifier. The present patent application further relates to a radio beacon and to an onboard unit for carrying out this method.

2. Background Art

Onboard units (OBUs) are electronic devices carried by vehicles so as to be able to identify the vehicles in a wireless manner via radio, for example for the purpose of settling tolls in electronic road toll systems. OBUs can be implemented in the form of active or passive radio transponders, radio frequency identification (RFID) chips, near field communication (NFC) chips, dedicated short range communication (DSRC) transceivers, wireless access in vehicular environments (WAVE) and wireless local area network (WLAN) nodes, or the like. EP 2 299 409 A1 describes the use of an RFID chip in a vehicle in order to identify the vehicle when entering and exiting a parking space and thereby determine the time difference as the overall parking duration of the vehicle.

### BRIEF SUMMARY

It is an object of the present application to render such OBUs usable for settling parking fees. In a first aspect, this object is achieved by a method for generating a parking fee transaction for a vehicle, which comprises an onboard unit having an identifier, comprising the following steps:

wirelessly polling the identifier by a roadside radio beacon as a current identifier;

generating a parking fee transaction for the identifier if the current identifier is identical to a stored old identifier;

storing the current identifier as the old identifier;

waiting a predetermined time period; and

repeating the above steps.

The present application is based on the finding that, by comparing the identifiers of OBUs located in the radio coverage range of the beacon—wherein the identifiers can be wirelessly polled at a particular time—to identifiers polled at an earlier time, it is possible to establish those identifiers, and consequently those OBUs and the vehicles thereof, which were present in the radio coverage range at both times and therefore almost certainly parked there. An astoundingly simple method for generating parking fee transactions is thus created, which can be scaled for any arbitrary number of parking spaces in the radio coverage range of a radio beacon.

According to an embodiment, a position of the onboard unit is wirelessly polled together with the identifier and the parking fee transaction is only generated if, in addition to said identifiers being identical, the position is located in a predetermined area. This allows excessive radio coverage ranges of the radio beacon to be dealt with, for example when the parking area is smaller than the radio coverage range of the radio beacon.

A status of the onboard unit may also be wirelessly polled together with the identifier, and the parking fee transaction is only generated if, in addition to said identifiers being identical, the status is also identical to a predetermined value. It can thus be assured that parking fee transactions are only generated for those OBUs that have set a corresponding “parking status”. For example, OBUs of vehicles located only temporarily in the radio coverage range of the radio beacon because they are temporarily stopped next to parked vehicles in a traffic jam may be ignored; and conversely, by deliberately setting the parking status on the OBU, a user can indicate that he is now parked and would like to pay the parking fees.

The generated parking fee transactions can be further processed and settled in a wide variety of ways. In a first embodiment, the parking fee transactions are wirelessly transmitted from the radio beacon to the onboard unit, where they are charged, for example, against a credit balance that is kept in the onboard unit (an “electronic wallet”) as a debit transaction. According to an alternative embodiment, the generated parking fee transactions are transmitted from the radio beacon to a back office, for example a toll back office of a road toll system, a bank computer, a credit card billing center or the like, and are charged there against a bank, credit or debit account of the user associated with the OBU identifier.

The method operates in steps of the predetermined waiting time period and can accordingly charge fees for parking durations in these time units. For instance, the predetermined time period may be 1 to 30 minutes, including being a predetermined time period of 5 to 20 minutes, which further includes a predetermined time period of 10 minutes, whereby short durations of less than 10 minutes remain free of charge and sufficient precision in terms of time is achieved for longer durations.

In a second aspect, a radio beacon is created for generating a parking fee transaction for a vehicle, which comprises an onboard unit having an identifier, wherein the radio beacon has a radio coverage range covering at least a parking space and is configured

to wirelessly poll the identifier of an onboard unit located in the radio coverage range as a current identifier;

to generate a parking fee transaction for the current identifier if the current identifier is identical to a stored old identifier;

to store the current identifier as the old identifier; and

to repeat these steps after a predetermined time period.

The radio beacon is advantageously configured to also wirelessly poll a position of the onboard unit together with the identifier and to generate the parking fee transaction only if, in addition to said identifiers being identical, the position is located in a predetermined area.

The radio beacon may be configured to also wirelessly poll a status of the onboard unit together with the identifier and to generate the parking fee transaction only if, in addition to said identifiers being identical, the status is also identical to a predetermined value.

It may be favorable if the radio beacon has a radio coverage range covering at least two parking spaces and is configured

to wirelessly poll the identifiers of all onboard units located in the radio coverage range as current identifiers;

to generate a parking fee transaction for any current identifier that is identical to a stored old identifier;

to store the current identifiers as old identifiers; and

to repeat these steps after the predetermined time period.

To this end, the radio beacon can calculate a parking space occupancy status by comparing the number of current identifiers to the number of parking spaces in the radio coverage range.

Reference is made to the above comments regarding the method in terms of the advantages of the radio beacon.

In a third aspect, an onboard unit is created for a vehicle, having a unique identifier and a stored modifiable status and comprising a transceiver for transmitting the identifier and the status in response to a wireless poll of a radio beacon, the onboard unit being characterized by having a first operating mode and a second operating mode, between which the unit can be switched by way of a switch, wherein the status indicates the respective operating mode of the onboard unit.

The onboard unit is therefore suited in particular for those embodiments and of the radio beacon, in which these consider a status that is set in the OBU and generate parking fee transactions only for those OBUs for which the user has set the parking mode or parking status.

The onboard unit may be equipped with a position determination device for determining the current position of the onboard unit and is configured to transmit the position thereof in response to a wireless poll of the radio beacon.

According to an embodiment, the onboard unit can be equipped with a movement sensor, which switches the onboard unit to the first operating mode when a movement thereof exceeds a threshold value and/or switches the onboard unit to the second operating mode when no movement thereof is detected for a period that exceeds a minimum time period. Automatic, movement-controlled switching between the two operating modes, these being the first (tolling) mode for movement and the second (parking) mode for standstill over extended periods, can thus be achieved.

The tolling mode of the onboard unit, in which the same, for example, communicates as a conventional road toll OBU with tolling radio beacons on the way, can be utilized to settle a parking fee transaction, which was received in the parking mode from a parking radio beacon, using the infrastructure of the road toll system. After leaving the parking mode and the radio coverage range of the parking radio beacon, the OBU transmits the parking fee transaction to the first tolling radio beacon it encounters on the way, for example, so as to pay the parking fee via the settling system of the tolling radio beacon.

It is particularly favorable if the onboard unit has a power-saving third operating mode, which it temporarily enters from the second operating mode after receiving a wireless poll or parking fee transaction. Because the wireless polls of a parking radio beacon are issued comparatively infrequently, for example every 10 minutes, the onboard unit can thus save a considerable amount of power.

### BRIEF DESCRIPTION OF THE DRAWINGS/FIGURES

Embodiments will be described in more detail hereafter with reference to the accompanying drawings. In the drawings:

FIG. 1 shows a schematic overview of the communication of an onboard unit in the tolling mode with tolling radio beacons on the way on a road, according to an example embodiment.

FIG. 2 shows a schematic overview of the communication of onboard units in the parking mode with a parking radio beacon during parking, according to an example embodiment.

FIG. 3 is a block diagram and FIG. 4 is a front view of an exemplary onboard unit according to an example embodiment.

FIG. 5 is a state transition diagram of the part of the method according to an embodiment that is carried out in an onboard unit.

FIG. 6 is a flow chart of the part of the method according to an embodiment that is carried out in a parking radio beacon.

Embodiments will now be described with reference to the accompanying drawings.

### DETAILED DESCRIPTION

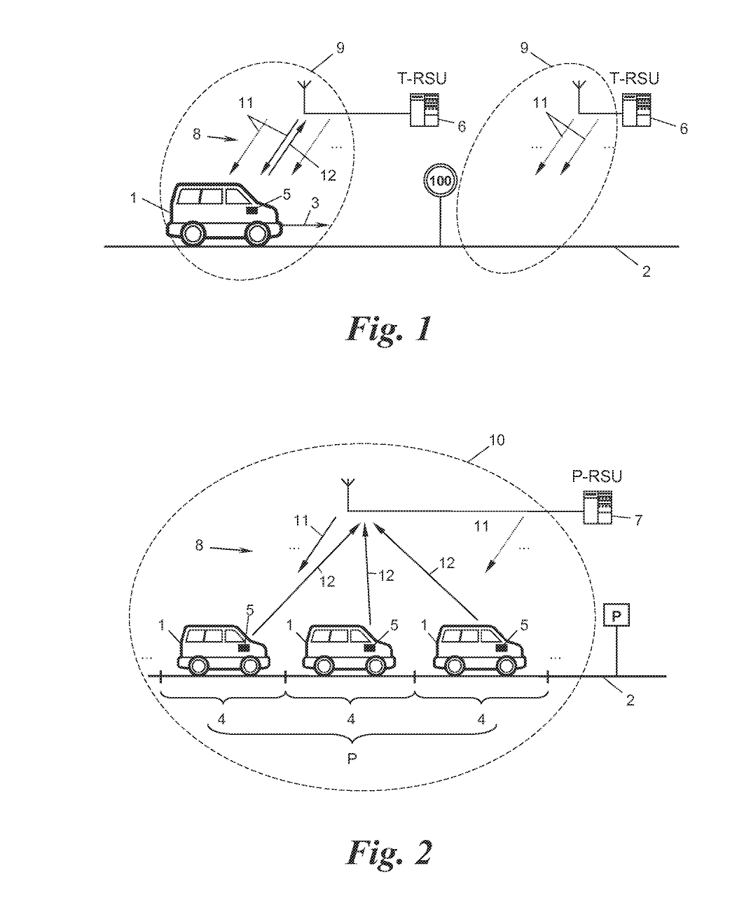

In FIG. 1, a vehicle 1 is moving on a road 2 at a speed and in a driving direction 3, and in FIG. 2 several vehicles 1 are parked in each case in a parking space 4 of the road 2. The road 2 can be any arbitrary traffic or parking area, for example an expressway, a highway or an entire road system in FIG. 1, or a shoulder, a large parking space or a parking garage in FIG. 2; all of these are considered to be covered by the general concept of “road” 2.

Each of the vehicles 1 is equipped with an onboard unit (OBU) 5, which is able to carry out radio communication 8 with roadside radio beacons (roadside units, RSUs) 6, 7. The OBUs 5 can be separate devices or an integral part of the vehicle electronics system. The radio communication 8 is short range or dedicated short range communication (DSRC), such as according to the standards CEN-DSRC, ITS-G5, IEEE 802.11p, WAVE, WLAN, RFID, NFC or the like. The radio beacons 6, 7 thus have a respective locally delimited radio coverage range 9, 10.

FIGS. 1 and 2 show two different types of radio beacons 6, 7 and application scenarios of the described components. The radio beacons 6 of FIG. 1 are “tolling” radio beacons (tolling roadside units, T-RSUs) that are set up in a geographically distributed manner along the road 2. With the aid of periodically broadcast wireless polls 1, the tolling radio beacons 6 request all passing OBUs 5 to establish radio communication 8, as is illustrated based on the exemplary response 12. So as not to “miss” any passing OBU 5 due to the potentially high speed of the vehicle 1, the wireless polls 11 of the tolling radio beacons 6 are broadcast at relatively short intervals, for example every 100 ms. For the wireless polls 11, for example, so-called wave service announcement (WSA) messages are used in the WAVE standard, and so-called beacon service table (BST) messages are used in the CEN-DSRC standard.

Successful radio communication 8 with a passing OBU 5 substantiates that the OBU 5 is located in the locally delimited radio coverage range 9 of the tolling beacon 6, whereby a fee (“toll”) can be charged for usage of the location of the tolling radio beacon 6. For example, the tolled location usage can be the driving on a road section, the entering of a particular territory (“city toll”) or the like.

In contrast, “parking” radio beacons (parking roadside units, P-RSUs) 7 are employed in the parking scenario of FIG. 2, which use a wireless poll 11, for example a WSA or BST message, to request all the OBUs 5 located in the radio coverage range 10 to provide response messages 12 so as to charge a fee for the usage of the parking spaces 4, as will be described in greater detail hereafter. To this end, a parking radio beacon 7 may be in charge of one or more parking spaces 4, which together form a parking area P.

Because parked vehicles 1 are stopped, a parking radio beacon 7 can broadcast the wireless polls 11 thereof at considerably longer time intervals ΔT than the tolling radio beacon 6 of FIG. 1, for example every 10 minutes, which also defines the time resolution of the parking time billing.

The radio coverage range 10 of the parking radio beacon 7 can be adapted to the spatial expansion of the parking spaces 4 using optional measures, for example directional antennas, so as to avoid responses 12 of OBUs 5 of vehicles 1 that are not parked, for example passing vehicles. As an alternative or in addition, the OBUs 5 of the vehicles 1 can also be caused to assume different operating modes, which are adapted in each case to the scenarios of FIGS. 1 and 2, and more particularly a first toll operating mode (tolling mode, TM) for responses 12 to wireless polls 11 from tolling radio beacons 6, and a second parking operating mode (parking mode, PM) for responses 12 to wireless polls 11 from parking radio beacons 7. In the wireless polls 11, the radio beacons 6, 7 can optionally broadcast a respective beacon identifier, which indicates whether it is a tolling radio beacon 6 or a parking radio beacon 7. The beacon identifier can, for example, be indicated as a service of the beacon as part of a WSA or BST message.

Of course, the tolling radio beacons 6 and parking radio beacons 7 can also be implemented by one and the same physical unit, which alternately or simultaneously performs the functions of a tolling radio beacon and a parking radio beacon 6, 7. Such a combined unit 6, 7 can thus broadcast wireless polls 11 with the beacon identifier of a tolling radio beacon, for example continually at short intervals, and wireless polls 11 with the beacon identifier of a parking radio beacon 7 at longer intervals ΔT, which is to say occasionally “interspersed”. Such a radio beacon 6, 7 is then in charge of both charging a toll for a road section of the road 2 and charging a fee for a parking area P, for example.

Depending on the operating mode TM or PM of the OBU 5, and depending on the received beacon identifier, the OBU 5 can, for example, respond only to tolling radio beacons 6 if the OBU is in the tolling mode TM or only to parking radio beacons 7 if the OBU is in the parking mode PM.

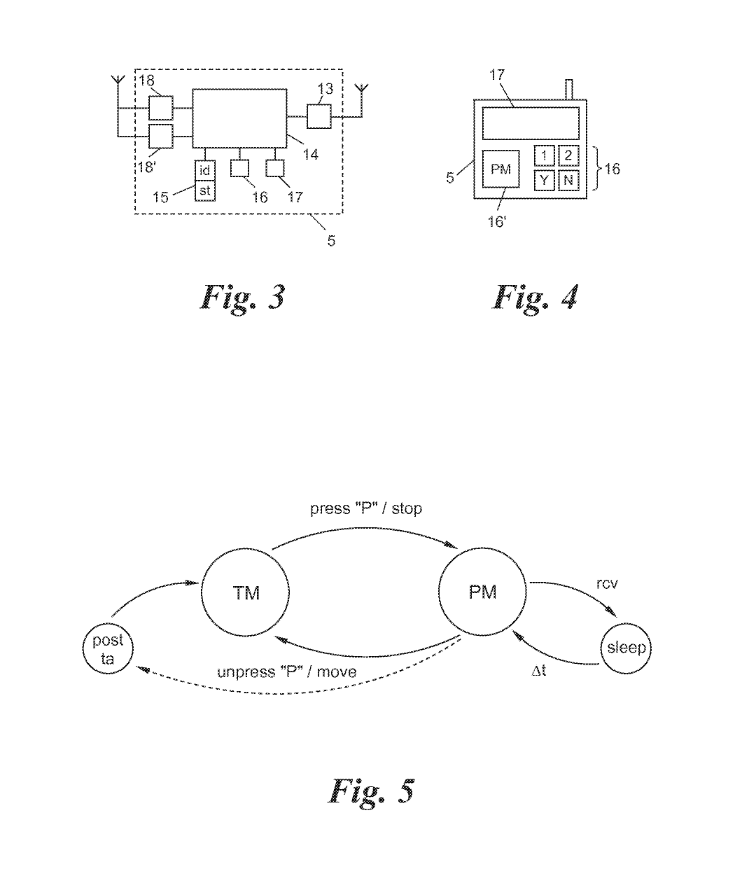

The operating mode of an OBU 5 can further be encoded as a data message (status) st and transmitted as part of the response 12. A radio beacon 6, 7 can appropriately evaluate the status st received in a response 12, so that tolling radio beacons 6 only charge tolls for the passage of OBUs 5 where status st=“TM”, and parking radio beacons 7 only charge fees for the parking of those OBUs 5 where status st=“PM”. Moreover, the OBUs 5 can also measure their own respective positions p and transmit these to the parking radio beacons 7, which compare the received positions p to the respective parking areas P and only charge fees for the parking of those OBUs 5, the positions p of which are within the respective parking area P. This will be described in more detail hereafter with reference to FIGS. 3 to 6.

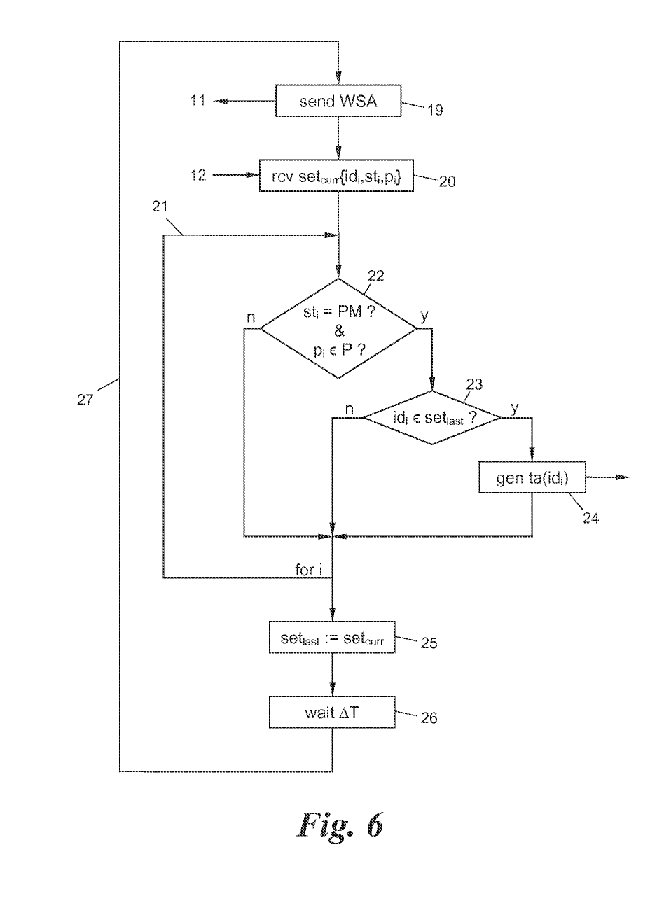

FIG. 3 shows an exemplary block diagram, FIG. 4 shows an exemplary outside view, and FIG. 5 shows an exemplary state transition diagram of an OBU 5, which can be switched between (at least) two operating modes TM and PM in accordance with the application scenarios of FIGS. 1 and 2. According to FIG. 3, to this end an OBU 5 comprises a transceiver 13 (for example according to one of said DSRC standards) for carrying out the radio communication 8, a microprocessor 14 controlling the transceiver 13, a memory 15, an input device 16, and an output device 17. The input and output devices 16, 17 can also be implemented in a manner that differs from the shown keyboard and monitor output, for example by way of voice input and output, sensor systems, advisory tones and the like. The input and output devices 16, 17 can also be formed by physically separate components such as car radios, navigation devices, smartphones, PDAs, tablets and the like and can be connected to the microprocessor 14 by wire or wirelessly, for example by way of NFC, Bluetooth®, WLAN or infrared.

The OBU 5 can optionally also comprise a movement sensor 18, for example in the form of a satellite navigation receiver for a global navigation satellite system (GNSS), such as GPS, GLONASS, GALILEO and the like; instead of a GNSS receiver, it is also possible to use any other type of movement sensor 18, for example an inertia sensor (inertial measurement unit, IMU) or a sensor that is connected to components of the vehicle 1, for example a connection to the speedometer or engine of the vehicle 1.

In the simplest case, the movement sensor 18 can also be only a connection to the vehicle electronics system, for example the ignition lock of the vehicle, so that the position of the key (engine running-not running), for example, indicates the (anticipated) movement or parking status of the vehicle.

The OBU 5 can optionally also be equipped with a position determination device 18′, which is able to determine the current position p of the OBU 5—in response to a poll, periodically or continuously. The position determination device 18′ can operate in any manner that is known in the art, for example by way of radio triangulation in a network of geographically distributed radio stations, which can be formed directly by the radio beacons 6, 7 or by base stations of a mobile communication network, for example, or by way of evaluation of the cell identifiers of a cellular mobile communication network, and the like. The position determination device 18′ may be a satellite navigation receiver for position determination in a GNSS and in particular can also be formed by the same GNSS receiver that is used for the movement sensor 18.

In addition to the appropriate application and control programs and data, the memory 15 of the OBU 5 includes a unique identifier id of the OBU 5, which is established and saved, for example, during the output or user-specific initialization of the OBU 5 and which uniquely identifies the OBU 5 and/or the user thereof and/or the vehicle 1 and/or a settlement account of the user. The OBU identifier id is transmitted together with every response message 12 from the OBU 5 to a radio beacon 6, 7 so as to uniquely identify the OBU 5 with respect to the radio beacon 6, 7.

The memory 15 can further include the status st, which indicates the operating mode TM or PM of the OBU 5 for the corresponding scenario of FIG. 1 or 2. The status st can be modified or adjusted both depending on a movement (or non-movement) of the OBU 5 measured by the movement sensor 18 and by a user selection via the input device 16. For this purpose, the input device 16 may, for example, comprise a lockable button 16′ (FIG. 4), which is labeled “PM” for “parking mode” PM and switches the OBU 5 to the parking mode PM by pressing and locking and sets the status st to the value “PM”. The OBU 5 is reset to the tolling mode TM and the status st is set to the value “TM” by releasing or unlocking the button 16′. The output device 17 can optionally output appropriate advisory and/or confirmation messages.

FIG. 5 shows several of the possible operating states of the OBU 5 again in detail in the form of a state transition diagram. The OBU 5 can be switched from the tolling mode TM into the parking mode PM by pressing the button 16′ and/or if the movement sensor 18 determines no movement of the OBU 5 over a minimum time period of 5 minutes, for example. The OBU can be set from the parking mode PM back to the tolling mode TM by releasing the button 16′ and/or by a movement of the OBU 5 detected by the movement sensor 18.

In the parking mode PM, the OBU 5 can temporarily assume a power-saving sleep mode (“sleep”), and more particularly as soon as it has received a wireless poll 11 of a parking radio beacon 7 and sent a response 12. The OBU 5 can also wake up from the sleep mode after a predetermined time period Δt has lapsed and return to the parking mode PM. The time period Δt may be shorter than the time period Δt between consecutive wireless polls 11 of a parking radio beacon 7. As an alternative or in addition, the OBU 5 could also be awakened again by receiving a subsequent wireless poll 11.

FIG. 6 shows a method for generating parking fee transactions in the application scenario of FIG. 2 that may be being carried out in a parking radio beacon 7 in cooperation with the OBU 5 of FIGS. 3 to 5.

In a first step 19, a wireless poll 11 is broadcast by the parking radio beacon 7 so as to request the OBUs 5 located in the radio coverage range 10 to provide responses 12. In step 20, the responses 12 arriving from the OBUs 5 are received, wherein each response 12 includes at least the respective identifier idᵢ of the OBU 5 with the index i and—optionally—the status stᵢ thereof and/or the position pᵢ thereof determined by the position determination device 18′. The received identifiers idᵢ, statuses stᵢ and positions pᵢ are temporarily stored in the parking radio beacon 7 as a current dataset set_{curr}.

Thereafter, a check is carried out within a loop 21 covering all received identifiers idᵢ as to whether or not the respective status stᵢ is set to the parking mode “PM”, see decision 22. In addition (or as an alternative), it can be checked in the decision 22 whether or not the respective position pᵢ—provided this was transmitted—falls within a predetermined geographical region, more particularly the parking area P of the parking radio beacon 7. If only some of the conditions that are checked in decision 22 are met (branch “n” of 22), the subsequent steps 23 and 24 are skipped and the loop 21 is continued or exited for step 25 upon completion. In contrast, if all the conditions are met, which is to say in the present case: stᵢ=PM and pᵢεP (branch “y” of 22), it is checked in a further decision 23 whether the respective identifier idᵢ corresponds to a previously stored “old” identifier id_{i,last}, which is to say whether or not it occurs in a dataset setₗₐₛₜ{id_{i,last}} of old identifiers id_{i,last}. These “old” identifiers id_{i,last} were determined during an earlier execution of the method and stored in the dataset setₗₐₛₜ as will be described hereafter.

If the respective current identifier idᵢ does not agree with any old identifier id_{i,last}, which is to say does not occur in the dataset setₗₐₛₜ (branch “n” of 23), the loop 21 is continued or exited for step 25 after it is completed; if there is agreement (branch “y” of 23), the method branches to step 24, in which a parking fee transaction ta(idᵢ) is generated for the current identifier idᵢ, as will described in greater detail later.

After step 24, the loop 21 is continued or, after completion thereof, a transition is made to step 25.

In step 25, the current identifiers idᵢ determined in step 20 are resaved as “old” identifiers id_{i,last}, which is to say the current dataset set_{curr} is (now) stored as an “old” dataset setₗₐₛₜ.

Thereafter, in step 26, a wait is carried out for the predetermined time period ΔT, which is between the individual wireless polls 11 of the parking radio beacon 7, and then the method is repeated (loop 27).

During the next repetition in the loop 27, the previously determined current identifiers idᵢ now constitute the “old” identifiers id_{i,last}, and if in step 20 again “new” current identifiers idᵢ are determined, these can then be compared in step 23 to the “old” identifiers id_{i,last} from the last dataset setₗₐₛₜ. As a result, it is checked during each loop execution 27 whether or not an OBU identifier idᵢ determined by a parking radio beacon 7 based on a wireless poll 11 was already present during a wireless poll 11 dating back by the time period ΔT; if so, a vehicle 1 comprising an OBU 5 having this identifier idᵢ has obviously spent at least the time period ΔT in the radio coverage range 10 of the parking radio beacon 7, so that a corresponding parking fee transaction ta(idᵢ) can be generated for the OBU identifier idᵢ for parking over the time period ΔT (step 24).

The parking fee transactions ta(idᵢ) generated in step 24 can be settled directly by the radio beacon 7, for example by charging these to a user account that is kept in the radio beacon 7. Alternatively, the parking fee transactions ta(idᵢ) can be forwarded by the radio beacon 7 to a remote back office (not shown), which keeps user accounts, toll accounts, bank accounts, credit accounts and the like under the identifiers idᵢ, so that the parking fee transactions ta(idᵢ) can be charged there against a corresponding settlement account. However, it is also possible for the generated parking fee transaction(s) ta(idᵢ) to be returned from the radio beacon 7 to the OBU 5 with the identifier idᵢ and to be charged there against a settlement account (an “electronic purse”) that is kept in the OBU 5.

Another option is to temporarily store the parking fee transaction(s) ta(idᵢ) returned from the parking radio beacon 7 to the OBU 5 in the OBU 5 and, when the OBU 5 returns to the tolling mode TM, have the OBU 5 send it/them to a tolling radio beacon 6 on the way for settlement purposes, as if it were a toll transaction. FIG. 5 shows a corresponding operating mode “post ta”, which the OBU 5 temporarily assumes after returning from the parking mode PM and in which it awaits the next tolling radio beacon 6 on the way, so as to deliver the parking fee transaction(s) ta(idᵢ) to the same, whereupon the OBU again returns to the “normal” tolling mode TM.

The procedures shown in FIG. 6 can, of course, be appropriately modified according to programming methods known to a person skilled in the art. For example, the decision 22 could be eliminated or included in step 20, and it could be checked whether the status stᵢ of an identifier idᵢ is set to “PM” and/or the position p, of an identifier idᵢ falls in the area P, wherein then only those identifiers idᵢ, where status stᵢ=“PM” or position pᵢεP, are stored as current identifiers in the current dataset set_{curr}. The loop 21 could also be implemented differently and, for example, steps 22 to 24 or 23 to 24 could be carried out immediately after receipt of a response 12 for an identifier idᵢ if this takes place so quickly in terms of data processing that this can be done between consecutively arriving responses 12. It should be noted in this regard that, according to some DSRC standards, the responses 12 of several OBUs 15 replying to one common wireless poll 11 are variably spread over time so as to prevent collisions of responses 12, whereby sufficient time can remain between individual responses 12 for steps 22 to 24 or 23 to 24.

A parking radio beacon 7, the radio coverage range 10 of which covers several parking spaces 4, at the same time receives a complete overview of the occupancy status of the parking spaces 4 in its parking area P as a result of the responses 12 of the OBUs 5 in step 20. For this purpose, the beacon only needs to compare the number of identifiers idᵢ received in step 20 to the number of parking spaces 4 in the area P, so as to obtain a proportional or percentage-based utilization rate of the parking spaces 4, for example “80%” if 4 out of 5 parking spaces are occupied, and so forth. The parking space occupancy status thus determined can be sent to a back office for parking area management measures, for example.

### CONCLUSION

The invention is thus not limited to the shown embodiments, but encompasses all variants and modifications that are covered by the scope of the accompanying claims. While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the described embodiments should not be limited by any of the above-described exemplary embodiments, but should be defined only in accordance with the following claims and their equivalents.

What is claimed is:

1. A method for generating a parking fee transaction for a vehicle which has an onboard unit having an identifier, comprising the following steps in a roadside radio beacon:
wirelessly polling an identifier by the radio beacon as a current identifier;
generating a parking fee transaction for the identifier if the current identifier is identical to a stored old identifier;
storing the current identifier as the old identifier;
waiting a predetermined time period; and
repeating the steps.

2. The method according to claim 1, wherein a position of the onboard unit is also wirelessly polled together with the identifier and the parking fee transaction is only generated if, in addition to said current and old identifiers being identical, the position is located in a predetermined area.

3. The method according to claim 1, wherein a status of the onboard unit is also wirelessly polled together with the identifier and the parking fee transaction is only generated if, in addition to said current and old identifiers being identical, the status is identical to a predetermined value.

4. The method according to claim 1, wherein the parking fee transaction is transmitted from the radio beacon to the onboard unit via radio.

5. The method according to claim 1, wherein the parking fee transaction is transmitted from the radio beacon to a back office.

6. The method according claim 1, wherein the predetermined time period is 1 to 30 minutes.

7. The method according claim 1, wherein the predetermined time period is 5 to 20 minutes.

8. The method according claim 1, wherein the predetermined time period is 10 minutes.

9. A radio beacon for generating a parking fee transaction for a vehicle which has an onboard unit having an identifier, wherein the radio beacon has a radio coverage range covering at least one parking space and is configured
to wirelessly poll the identifier of an onboard unit located in the radio coverage range as a current identifier;
to generate a parking fee transaction for the current identifier if the current identifier is identical to a stored old identifier;
to store the current identifier as the old identifier; and
to repeat the wireless poll of the identifier of an onboard unit located in the radio coverage range as a current identifier, the generation of the parking fee transaction for the current identifier if the current identifier is identical to a stored old identifier, and the store of the current identifier as the old identifier after a predetermined time period.

10. The radio beacon according to claim 9, comprising the radio beacon being configured to also wirelessly poll a position of the onboard unit together with the identifier and to generate the parking fee transaction only if, in addition to said current and old identifiers being identical, the position is located in a predetermined area.

11. The radio beacon according to claim 9, comprising the radio beacon being configured to also wirelessly poll a status of the onboard unit together with the identifier and to generate the parking fee transaction only if, in addition to said current and old identifiers being identical, the status is also identical to a predetermined value.

12. The radio beacon according to claim 9, comprising the radio beacon having a radio coverage range that covers at least two parking spaces and being configured
to wirelessly poll the identifiers of all onboard units located in the radio coverage range as current identifiers;
to generate a parking fee transaction for any current identifier that is identical to a stored old identifier;
to store the current identifiers as old identifiers; and
to repeat the wireless poll of the identifiers of all onboard units located in the radio coverage range as current identifiers, the generation of a parking fee transaction for any current identifier that is identical to a stored old identifier, and the store of the current identifiers as old identifiers after the predetermined time period.

13. The radio beacon according to claim 12, comprising the radio beacon calculating a parking space occupancy status based on a comparison of the number of current identifiers to the number of parking spaces in the radio coverage range.

14. The radio beacon according to claim 9, wherein the radio beacon is configured to transmit the parking fee transaction to at least one of the onboard unit or a back office.

15. An onboard unit for a vehicle, having a unique identifier and a stored modifiable status and comprising a transceiver for transmitting the identifier and the status in response to a wireless poll of a radio beacon,
wherein the onboard unit has a first operating mode and a second operating mode, between which the unit can be switched by way of a switch, and is configured to respond in the second operating mode to wireless polls of a radio beacon, and
wherein the status indicates the respective operating mode of the onboard unit.

16. The onboard unit according to claim 15, wherein the onboard unit includes a position determination device configured to determine the current position of the unit and configured to transmit the position thereof in response to a wireless poll of the radio beacon.

17. The onboard unit according to claim 15, wherein the onboard unit includes a movement sensor configured to switch the onboard unit to the first operating mode when a movement thereof exceeds a threshold value.

18. The onboard unit according to claim 15, wherein the onboard unit includes a movement sensor configured to switch the onboard unit to the second operating mode when no movement thereof is detected for a period that exceeds a minimum time period.

19. The onboard unit according to claim 15, wherein the onboard unit is configured to transmit a parking fee transaction received from a radio beacon in the second operating mode to a further radio beacon in the first operating mode.

20. The onboard unit according to claim 15, wherein the onboard unit has a power-saving third operating mode that is temporarily entered from the second operating mode after receiving a wireless poll or parking fee transaction.
